(19) United States
(12) Patent Application Publication
(10) Pub. No.: US 2007/0150297 A1
(43) Pub. Date: Jun. 28, 2007

(54) Systems and Methods for Providing a Single Source to Identify Providers to Assist in the Purchase, Insurance, and Finance of Property

(76) Inventor: Angela M. Olson, Eden Prairie, MN (US)

Correspondence Address: MERCHANT & GOULD PC, P.O. BOX 2903, MINNEAPOLIS, MN, 55402-0903, US

(21) Appl. No.: 11/426,045

(22) Filed: Jun. 23, 2006

Related U.S. Application Data
(60) Provisional application No. 60/693,287, filed on Jun. 23, 2005.

(51) Int. Cl. G06Q 99/00

(52) U.S. Cl. 705/1

(57) ABSTRACT

Examples of the systems and methods described herein provide a user with a single source that allows the user to identify service providers to assist in the purchase, insurance, and finance of property such as real estate. The systems and methods also provide for advertising for goods and services associated with the property being sold. Revenue can be generated based on agreements with the goods and service providers of the systems and methods.

### RELATED APPLICATION

This application claims the benefit under 35 U.S.C. § 119(e) of U.S. Patent Provisional Application Ser. No. 60/693,287 filed on Jun. 23, 2005, the entirety of which is hereby incorporated by reference.

### TECHNICAL FIELD

Embodiments of the present invention relate to systems and methods that assist a user in selecting providers for the purchase, insurance, and finance of property.

### BACKGROUND

Users are faced with an assortment of decisions when renting or purchasing a high-ticket item such as real estate (e.g., condominium, town home, single family home). For example, a user must identify the desired property to rent or purchase. The user must also decide how to finance the purchase of the property, as well as how to insure the property. These decisions are typically made using a variety of criteria, including price and geographic location.

Users can become overwhelmed with the number of service providers that can assist the user in purchasing, insuring, and financing property. One problem associated with such variety is that there is no single, easily accessible source that can provide the user with information about selected service providers that can assist with all of the decisions associated with the purchase of property in a geographical region.

Further, information sources that do exist typically provide information related to only one facet of such a purchase (e.g., purchase, insurance, or finance). For example, a real estate provider can provide information related to locating real estate for rental or purchase, but typically does not provide information related to insuring or financing the rental/purchase.

It is therefore desirable to provide users with a single source that includes information and service providers to assist in the variety of decisions associated with the purchase of property, including locating the desired property, financing the property, and insuring the property.

### SUMMARY

Embodiments of the present invention relate to systems and methods that assist a user in selecting providers for the rental/purchase, insurance, and finance of property.

Examples of the systems and methods described herein provide a user with a single source that allows the user to identify service providers to assist in the rental/purchase, insurance, and finance of the property. Property can include any type of property for which it would be desirable to provide insurance. Examples of these types of property include real estate, motor homes, automobiles, boats, etc. Other types of property can also be used. The systems and methods also provide for advertising for goods and services associated with the property being sold. Revenue can be generated based on agreements with the goods and service providers of the systems and methods.

### BRIEF DESCRIPTION OF THE DRAWINGS

FIG. 1 is a schematic view of an example system that assists in the selection of providers for the purchase, insurance, and finance of property.

FIG. 2 is a schematic view of an example system that assists in the selection of providers for the purchase, insurance, and finance of real estate.

FIG. 3 is an example method for creating a system to assist in the selection of providers for the purchase, insurance, and finance of real estate.

FIG. 4 is an example method of creating another system in a new geographic area to assist in the selection of providers for the purchase, insurance, and finance of real estate in the new geographic area.

FIG. 5 is an example web-based system that assists in the purchase, insurance, and finance of real estate.

FIG. 6 is an example of a mortgage module of the system of FIG. 5.

FIG. 7 is an example of an example tool of the mortgage module of FIG. 5.

FIG. 8 is an example information module of the mortgage module of FIG. 5.

FIG. 9 is an example information module of the advertising module of FIG. 5.

FIG. 10 is an example development module of the information module of FIG. 9.

FIG. 11 is an example services module of the advertising module of FIG. 5.

FIG. 12 is an example classifieds module of the advertising module of FIG. 5.

FIG. 13 is an example news module of the advertising module of FIG. 5.

FIG. 14 is an example dining module of the advertising module of FIG. 5.

FIG. 15 is an example night life module of the advertising module of FIG. 5.

FIG. 16 is an example arts module of the advertising module of FIG. 5.

FIG. 17 is an example charitable module of the advertising module of FIG. 5.

FIG. 18 is a schematic view of another example system that assists in the selection of providers for the purchase, insurance, and finance of real estate.

FIG. 19 is an example method of providers to select a geographic area in which to advertise.

### DETAILED DESCRIPTION

Embodiments of the present invention relate to systems and methods for purchasing, insuring, and financing property.

Generally, embodiments of the systems and methods described herein provide a single resource that allows a user to purchase, insure, and finance property such as real estate, as well as provide advertising for goods and services of interest to the user. Revenue can be generated from embodiments of the systems and methods described herein through the sale of goods and services.

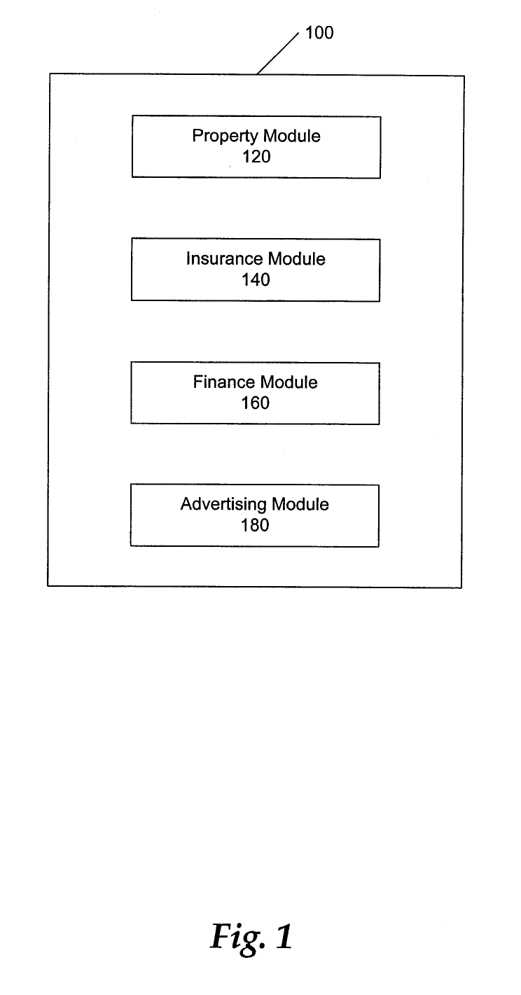

Referring now to FIG. 1, an example system 100 is shown. System 100 generally includes a property module 120, an insurance module 140, a finance module 160, and an advertising module 180. A user can access system 100 to find information in property module 120, insurance module 140, and finance module 160 associated with the purchase, insurance, and finance of property. A user can also access information associated with goods and services provided in advertising module 180.

Property module 120 provides information associated with the purchase of property. For example, property module 120 can include information associated with one or more real estate providers or agencies. In some embodiments, property module 120 can also include a classified section listing properties for purchase. A user can access property module 120 to assist the user in researching and purchasing a property.

Insurance module 140 provides information associated with insurance for the property. For example, insurance module 140 can include information associated with one or more insurance agencies that can provide insurance services for a user. For example, insurance module 140 can provide information associated with insurance agencies that can provide insurance for a property. A user can access insurance module 140 to assist the user in researching insurance for a property.

Finance module 160 provides information associated with the financing of the purchase of a property. For example, finance module 160 can include information associated with one or more lending institutions that can assist in the purchase of a property. For example, finance module 160 can include information associated with a lending institution that can provide a mortgage to assist in the purchase of a property. A user can access finance module 160 to assist the user in researching lending institutions that can assist in the purchase of a property.

Advertising module 180 provides information associated with other goods and services that may be of interest to a user that accesses system 100 to use one or more of property module 120, insurance module 140, and finance module 160. For example and as described in more detail below, advertising module 180 can include advertisements by goods and services providers associated with a particular geographic area corresponding to the geographic area of the providers listed in property module 120, insurance module 140, and finance module 160. In this manner, users who access system 100 to purchase, insure, and/or finance a property located in a particular geographic area can also identify goods and services in advertising module 180 for that geographic area.

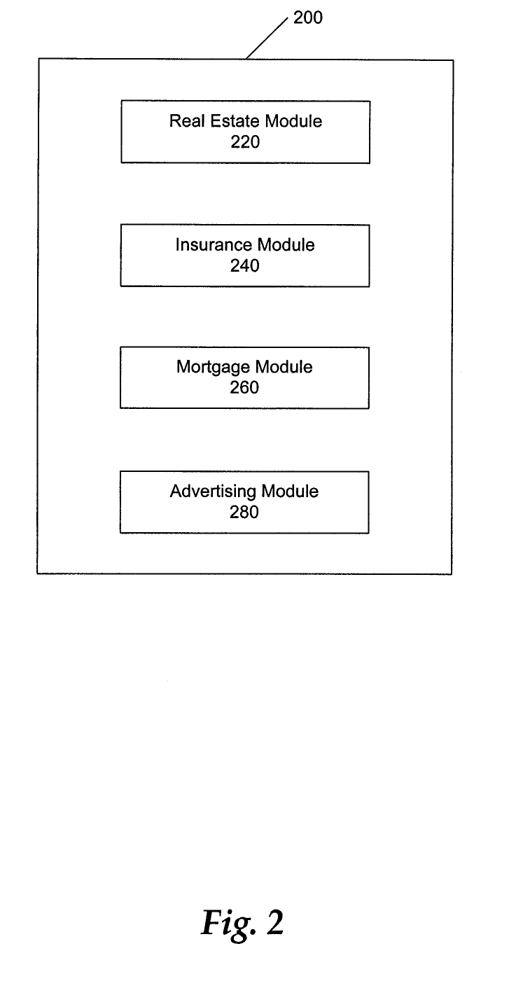

Referring now to FIG. 2, an example system 200 is shown. System 200 is similar to that of system 100 described above, except that system 200 is specifically configured for the sale of condominiums in a particular geographic area, such as a city located in a metropolitan area. System 200 includes a real estate module 220, an insurance module 240, a mortgage module 260, and an advertising module 280. A user can access system 200 to research and purchase condominiums listed in real estate module 220. The user can research and purchase insurance for a condominium using insurance module 240. In addition, the user can research and obtain a mortgage to the purchase of a condominium using mortgage module 260. Further, the user can access goods and services of interest to those that live in condominiums in the geographic area using advertising module 280.

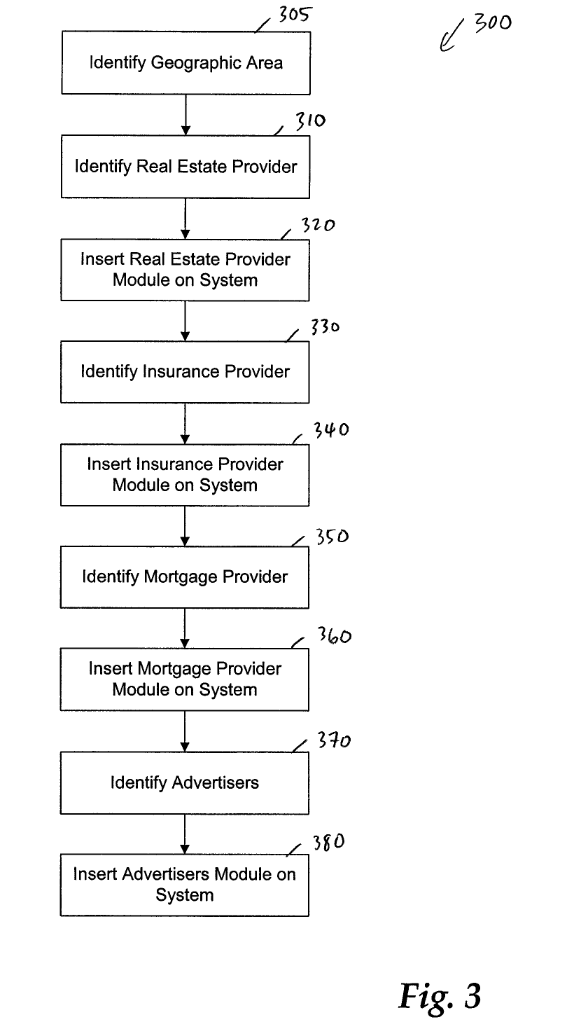

Referring now to FIG. 3, an example method 300 for creating a system such as system 200 is shown. Method 300 begins with the selection of a geographic area at step 305. A particular geographic area can include territories of various sizes such as, for example, a particular state, a particular county, a particular city, a particular portion of a city, and/or a particular zip code. In one example, a geographic area is selected by choosing a particular city or portion of a city that has a developing or developed market for condominium construction and sales. In the illustrated embodiment, the geographic area is selected to be a particular city that includes a growing condominium market.

Steps 310-380 of method 300 generally involve the selection of goods and/or service providers to be included with modules 220, 240, 260, and 280 of system 200. The goods and/or service providers can be selected based on one or more of a variety of criteria, including: (i) price; (ii) reputation or quality; and/or (iii) a previously established relationship.

Referring now to step 310, a real estate agency that sells condominiums in the selected geographic area is identified. In one example, the real estate agency is selected based on the reputation or quality of the real estate provider in the given geographic area. Typically, an agreement is reached with the real estate agency in which the real estate agency agrees to pay a fee or a commission/royalty to be listed in real estate module 220. For example, the real estate agency listed in real estate module 220 can pay a percentage commission based on an amount or number of sales generated through being listed in real estate module 220. In an alternative embodiment, if a suitable real estate agency cannot be identified in step 310, a new real estate agency associated with system 200 can be established in the particular geographic area.

Once a real estate agency is identified in step 310, the real estate agency is inserted into real estate module 220 at step 320. Once the real estate agency is inserted into real estate module 220, a user that accesses real estate module 220 of system 200 is referred to that real estate agency for the selection and purchase of a condominium.

Next, at step 330, an insurance provider is selected using criteria such as those described above for the selection of a real estate agency. Typically, an agreement is reached with the insurance provider in which the insurance provider agrees to pay a fee or a commission/royalty to be listed in insurance module 240. For example, the insurance provider listed in insurance module 240 can pay a percentage commission based on an amount or number of sales generated through being listed in insurance module 240. In an alternative embodiment, if a suitable insurance provider cannot be identified in step 330, a new insurance provider associated with system 200 can be established in the particular geographic area.

Once an insurance provider is identified in step 330, the insurance provider is inserted into insurance module 240 at step 340. Once the insurance provider is inserted into insurance module 240, a user that accesses insurance module 240 of system 200 is referred to that insurance provider for the selection and purchase of insurance for a condominium.

Next, at step 350, a mortgage provider is selected using criteria such as those described above for the selection of a real estate agency. Typically, an agreement is reached with the mortgage provider in which the mortgage provider agrees to pay a fee or a commission/royalty to be listed in mortgage module 260. For example, the insurance provider listed in mortgage module 260 can pay a percentage commission based on an amount or number of sales generated through being listed in mortgage module 260. In an alternative embodiment, if a suitable insurance provider cannot be identified in step 350, a new mortgage provider associated with system 200 can be established in the particular geographic area.

Once a mortgage provider is identified in step 350, the mortgage provider is inserted into mortgage module 260 at step 360. Once the mortgage provider is inserted into mortgage module 260, a user that accesses mortgage module 260 of system 200 is referred to that mortgage provider for the selection and purchase of financing for a condominium.

Next, at step 370, advertisers in the particular geographic area for advertising module 280 are identified. Typically, advertisers include goods and service providers that sell goods and services of particular interest to users who use system 200. For example, advertisers of the particular geographic area that provide goods or services of interest to those who purchase and live in condominiums can be selected. Typically, an agreement is reached with each advertiser in which the advertiser agrees to pay a fee or a commission/royalty to be listed in advertising module 280.

Once an advertiser is identified in step 370, the advertiser is inserted into advertising module 280 at step 380. Once the advertiser is inserted into advertiser module 280, a user that accesses advertising module 280 of system 200 and selects the advertiser is referred to advertiser for the selection and purchase goods and/or services from the advertiser.

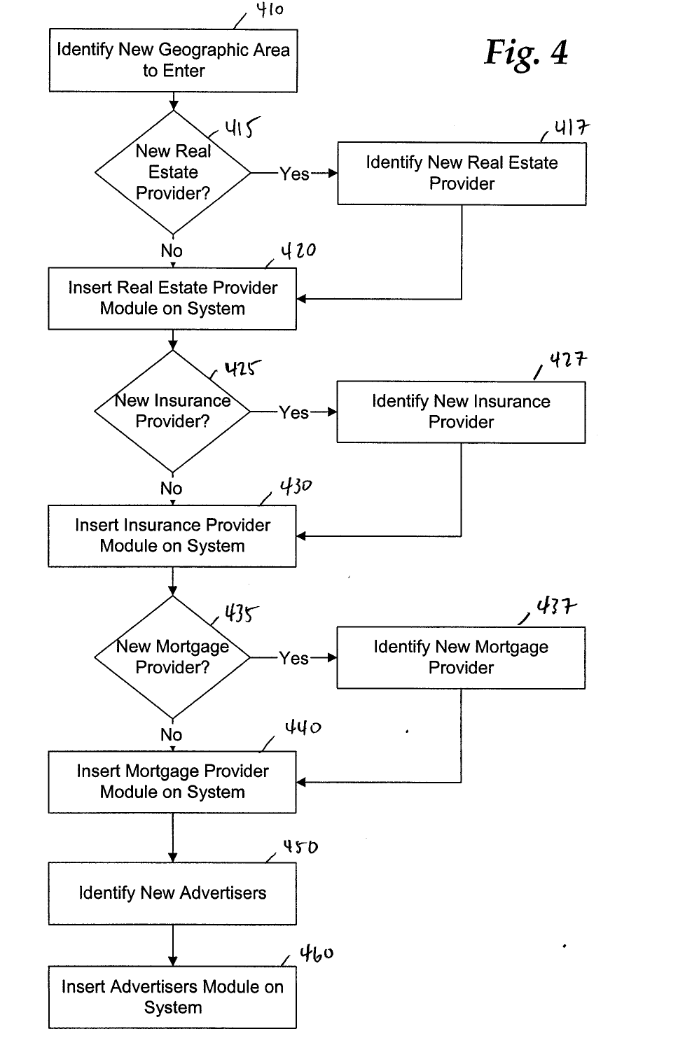

Referring now to FIG. 4, another example method 400 is shown. Method 400 generally involves expanding system 200 into a new geographic area. For example, once system 200 is established in a first geographic area, system 200 can be expanded to new geographic areas using method 400.

For example, system 200 can be implemented in a first market. Once system 200 is established in the first market, system 200 can be extended to a second market that is geographically distinct from the first market. In this manner, system 200 can be easily expanded into new geographic areas to increase the revenue generated by system 200 by increasing the base of users in the new geographic areas.

Beginning at step 410 of method 400, a new geographic area is identified. For example, a city in a different geographic area from that selected at step 305 of method 300 can be selected. The new geographic area can represent a new market that differs from the market for condominiums previously identified in method 300.

At step 415, a determination is made regarding whether or not a new real estate agency is to be selected. For example, a different real estate agency having an expertise in the condominiums available in the new geographic area can be selected. If a new real estate agency is to be selected, control is passed to step 417, and a new real estate agency is selected in a manner similar to that describe above in step 310 of method 300. In one example, a real estate agency having an existing relationship with system 200 can be given a first right of refusal for a new geographic area. For example, a real estate agency can purchase a right to be listed in system 200 developed for the new geographic area. Next, at step 420, the new or existing real estate agency is inserted into the real estate module 220 of system 200 for the new geographic area.

At step 425, a determination is made regarding whether or not a new insurance provider is to be selected for the new geographic area. This determination can be made in a manner similar to that described above with respect to step 415. If a new insurance provider is to be selected, control is passed to step 427 and the new insurance provider is selected. Next, at step 430, the new or existing insurance provider is inserted into the insurance module 240 of system 200 for the new geographic area.

Next, at step 435, a determination is made regarding whether or not a new mortgage provider is to be selected for the new geographic area. This determination can be made in a manner similar to that described above with respect to step 415. If a new mortgage provider is to be selected, control is passed to step 437 and the new mortgage provider is selected. Next, the new or existing mortgage provider is inserted into the mortgage module 260 of system 200 for the new geographic area at step 440.

Next, at step 450, advertisers for advertising module 280 of system 200 for the new geographic area are selected. Advertisers can be selected in a manner similar to that described above with respect to step 370 of method 300. For example, advertisers can be selected based on their reputation and presence in the new geographic area. In one embodiment, an advertiser can purchase a right of first refusal for a new geographic area, and the advertiser can exercise that right when system 200 is set up for the new geographic area. The selected advertisers are then inserted into advertising module 280 of system 200 for the new geographic area at step 460.

The particular order of the steps of methods 300 and 400 can be modified. For example, an insurance agency or a mortgage provider can be selected in steps 330-360 before selection of a real estate agency in steps 310-320. In addition, new or different providers can be selected at later intervals. For example, a new real estate agency can be selected and inserted into real estate module 220 if the existing real estate agency is under performing.

In addition, although method 300 is described with respect to selection of a single provider for each of modules 220, 240, and 260, in other embodiments multiple providers can be selected. For example, two real estate agencies can be selected and inserted into real estate module 220. A user that accesses real estate module 220 can select between the two real estate agencies listed therein. In some embodiments, system 200 can provide a rating for each of multiple providers to assist the user in the selection of a particular provider.

In another alternative embodiment, instead of selection of providers at steps 310, 330, and 350 of method 300, system 200 is configured to simply record information related to users that access modules 220, 240, and 260. This information (sometimes referred to as “leads”) can be sold to one or more providers who then follow up with the user to provide services. For example, insurance module 240 can be configured to record information related to users that access insurance module 240, and this information can be sold to an insurance agency. The insurance agency can contact the user to discuss the sale of insurance services to the user for his or her condominium purchase.

In some embodiments, agreements can be structured between the providers listed in modules 220, 240, 260, and 280 so that a user that purchases goods or services from one provider can receive a discount on goods or services from another provider. For example, an agreement can be structured between the lending institution listed in mortgage module 260 and the insurance provider listed in insurance module 240 so that a user that purchases a mortgage from lending the lending institution can receive a preferred or discounted rate for insurance purchased from the insurance agency. In another example, advertisers listed in advertising module 280 can provide discounts on good and/services to users of system 200. In this manner, users can be further encouraged to utilize system 200 when purchasing goods or services associated with condominiums, once again increasing the user base and revenue generated by system 200.

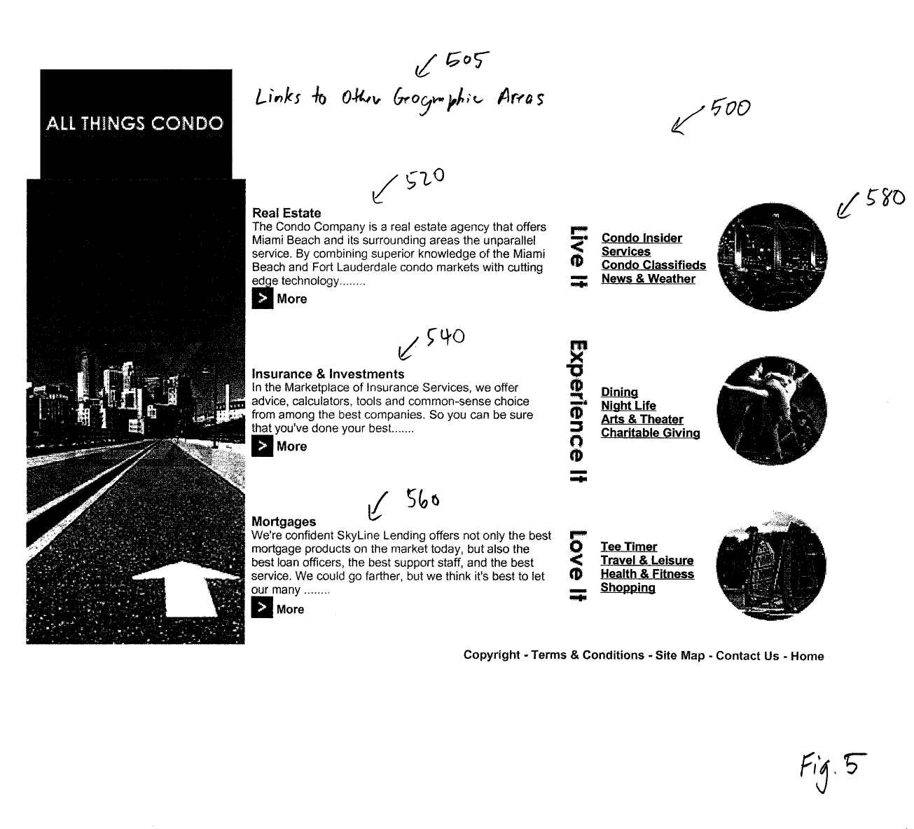

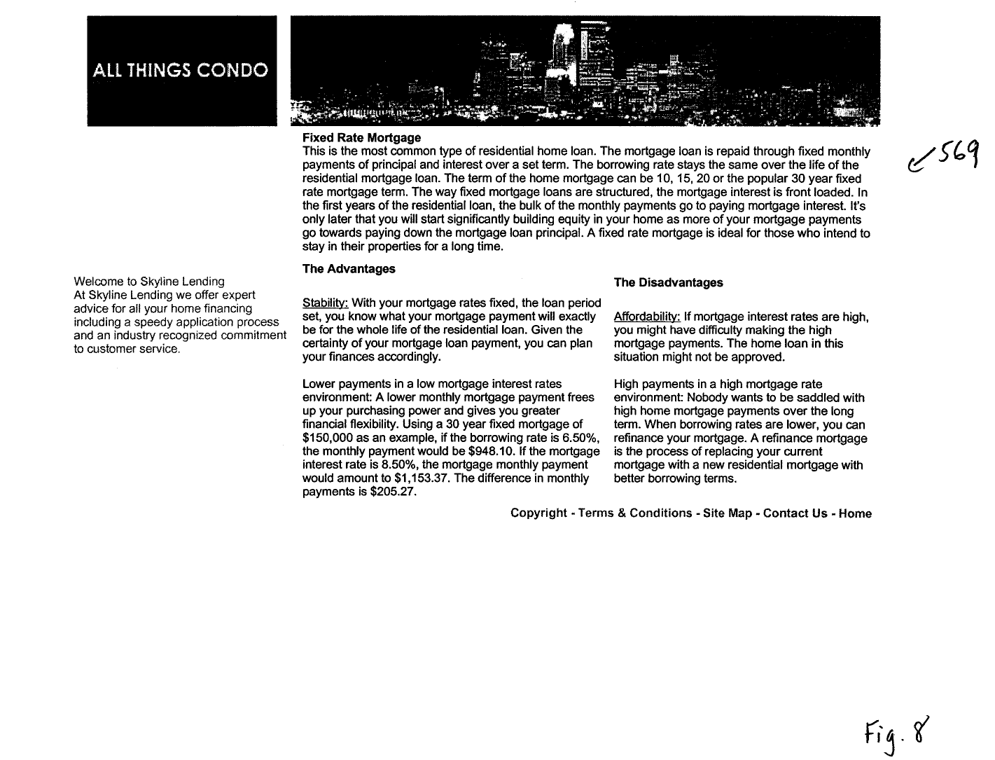

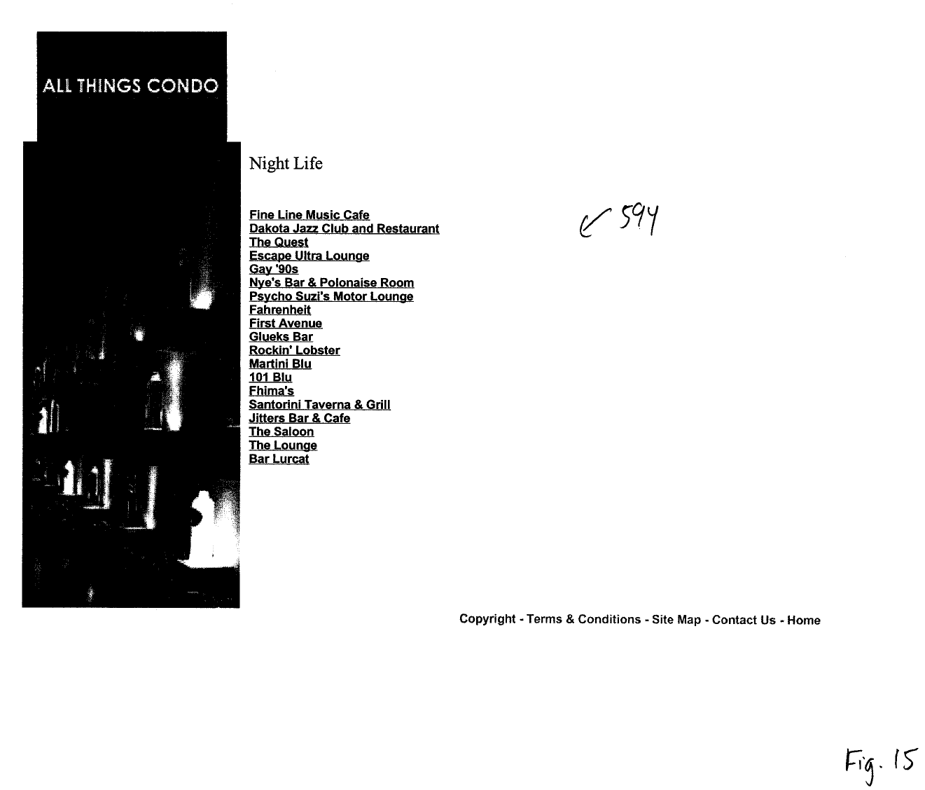

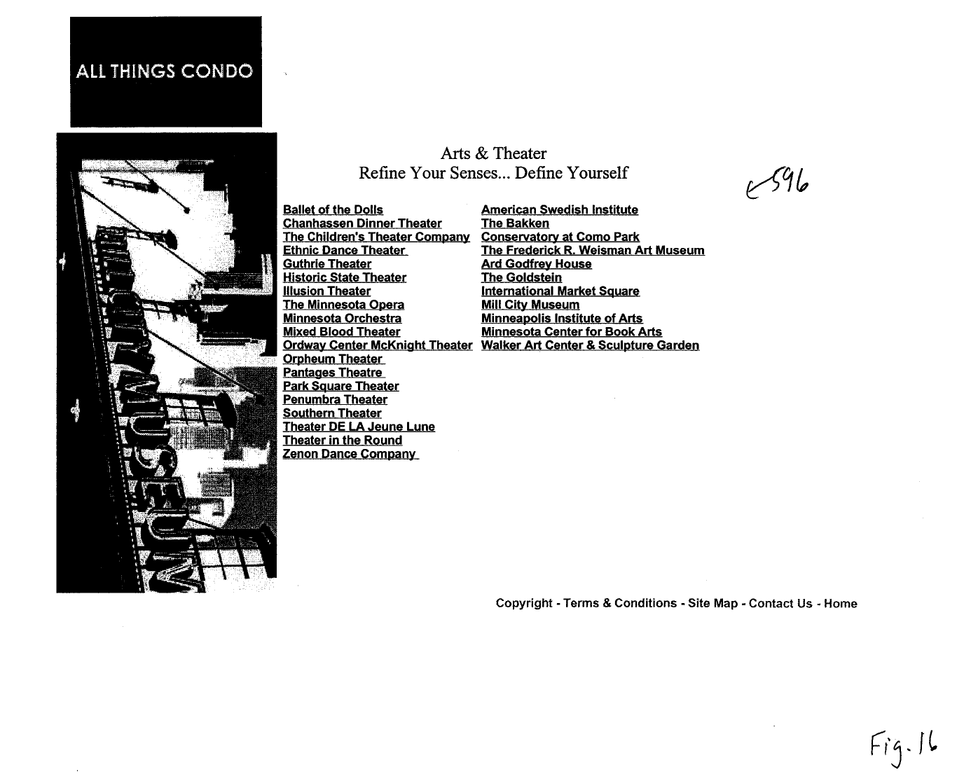

Referring now to FIGS. 5-17, an example system 500 is shown. System 500 is a web-based system including components similar to those described above with respect to systems 100 and 200. As shown in FIG. 5, system 500 generally includes a real estate module 520, an insurance module 540, a mortgage module 560, and an advertising module 580. A user can access system 500 over the Internet using typical methods, such as with a web browser on a computer connected to the Internet.

When the user selects the real estate module 520 of system 500, the user can access information related to condominiums and the real estate agency selected for module 520. For example, in one embodiment, the user is directed to the real estate agency's web site upon selection of the condominium listings module 520. In another embodiment, the user receives information and condominium listings from the real estate agency on system 500 upon selection of module 520.

In a similar manner, the user can access insurance and mortgage information upon selection of insurance module 540 and mortgage module 560. This information can include links to the insurance and lending providers selected for modules 540 and 560. This information can also include tools provided by system 500 and/or the insurance provider to help the user select the desired insurance and mortgage for the user's condominium.

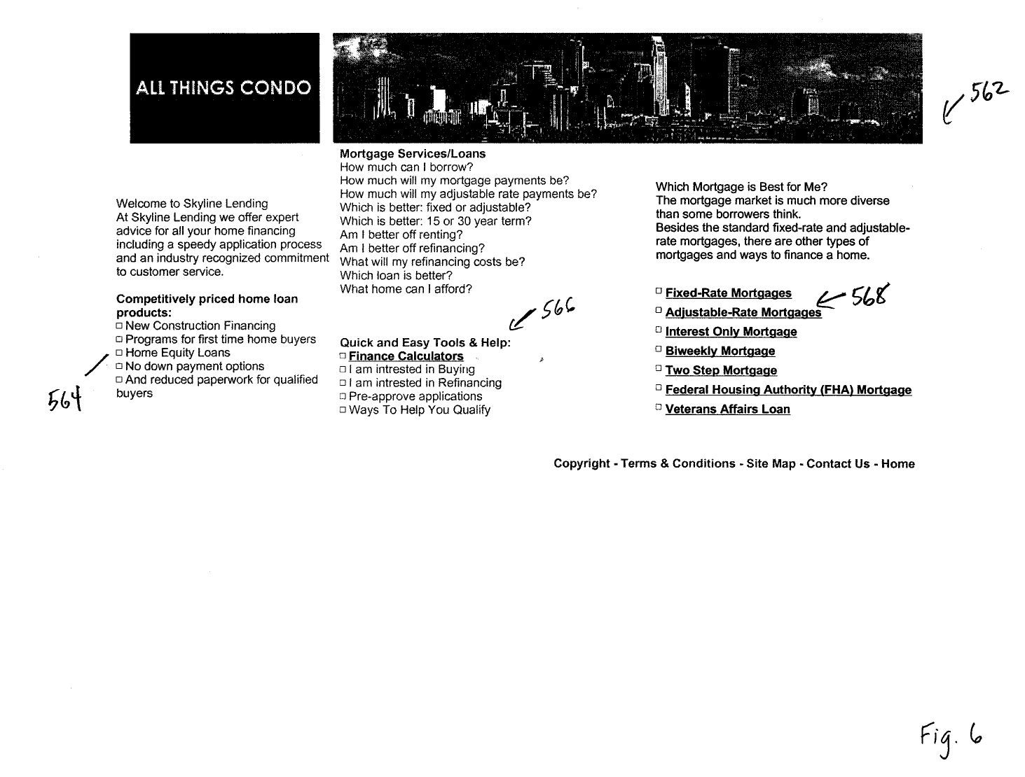

For example, upon selection of mortgage module 560, a user can be presented with a variety of information to assist the user in selecting and obtaining a mortgage for a condominium, as shown in FIGS. 6-8. For example, a user can access module 562 of system 500 shown in FIG. 6. Module 562 includes links 564 that allow the user to access products offered by the selected mortgage provider.

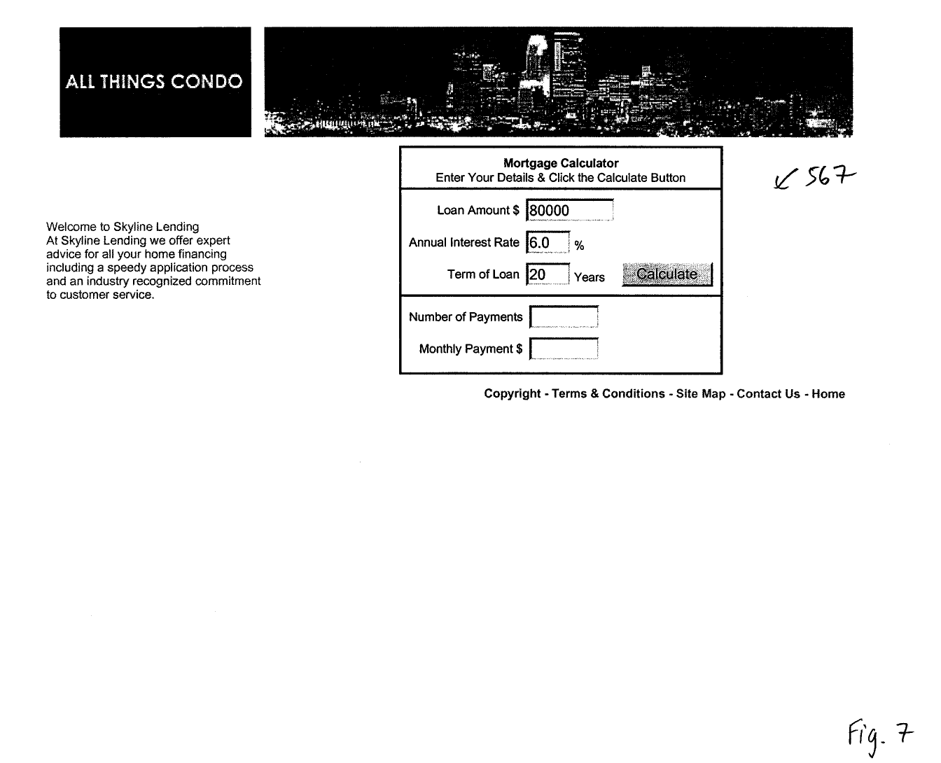

In addition, module 562 includes tools to assist the user in selecting a desired mortgage, such as financial calculator 567 shown in FIG. 7. Module 562 also includes general information related to the different kinds of mortgages available to the user, as well as in-depth information about each type of mortgage as shown, for example, in module 569.

Advertising module 580 includes additional information related to condominiums, news of interest to condominium owners, and advertising for providers of goods and services for condominium owners in the geographic area. Generally, module 580 can be arranged based on categories of interest, such as general information and entertainment.

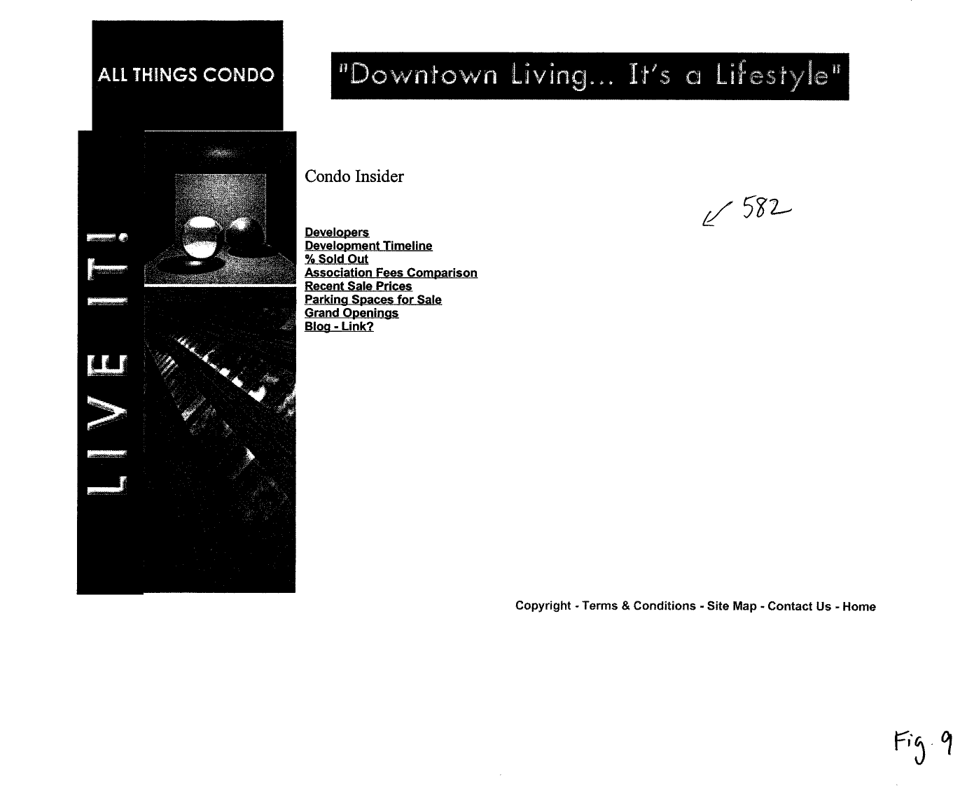

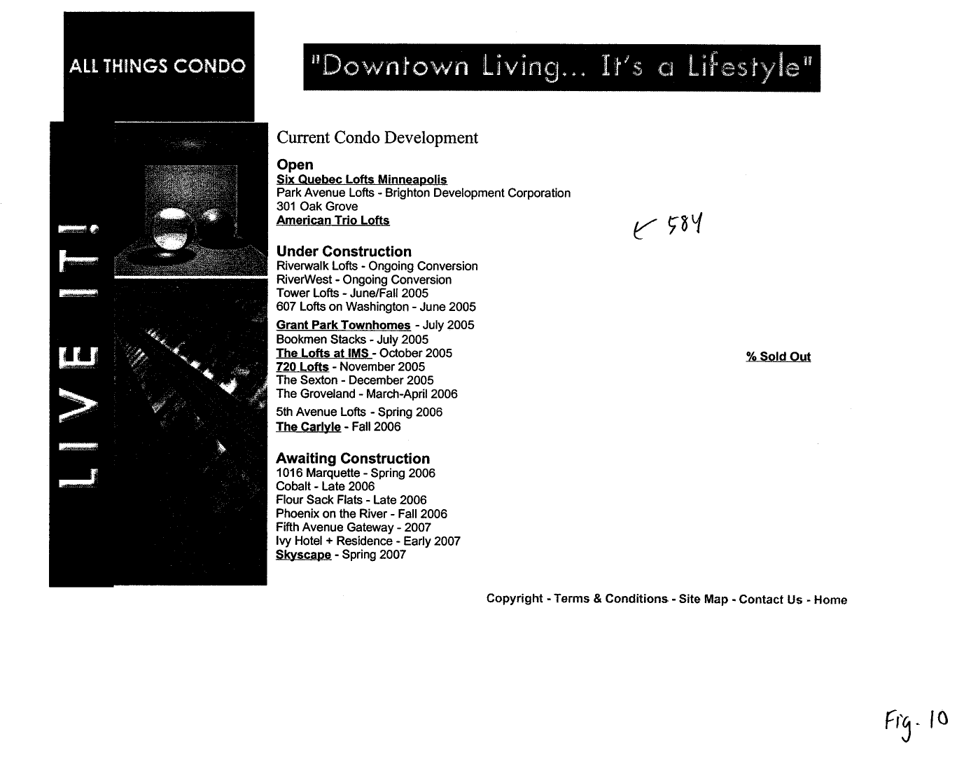

For example, module 580 includes module 582, shown in FIG. 9, which provides information related to the condominium market for the geographic area. Module 582 can include information related to current and proposed condominium projects, such as module 584 shown in FIG. 10. This information can include timelines for new construction and percentages of condominiums sold for existing condominium developments. In addition, module 582 can include other general information such as associate fee comparisons, recent sales prices, parking space sales, and information regarding grand openings of new condominium developments. In other embodiments, additional information such as user ratings and opinions can also be provided for each prospective condominium development.

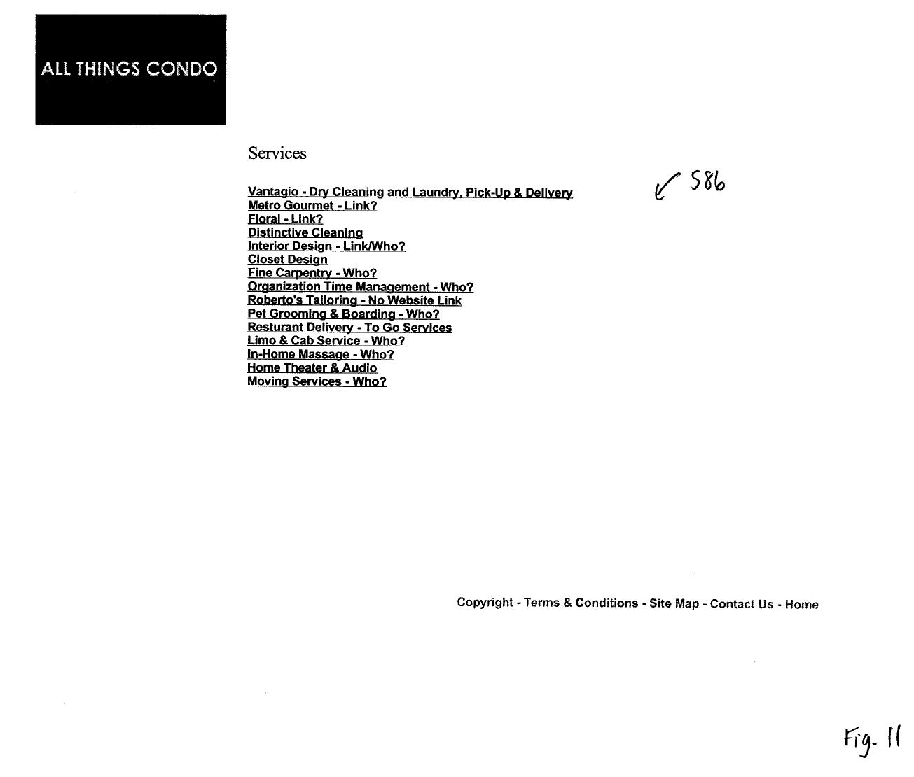

Module 580 also includes services module 586, shown in FIG. 11, which lists providers having goods and services of interest to a condominium owner in the geographic area. The providers can be categorized into categories such as, for example, dry cleaning, floral, interior design, carpentry, cab services, etc. Other types of services can also be listed. A user can select a service provider from one of the categories of module 586 to contact the provider to obtain goods or services. In alternative embodiments, module 586 can include ratings for particular providers, based on different criteria such as user opinions, to assist the user in selection of a provider.

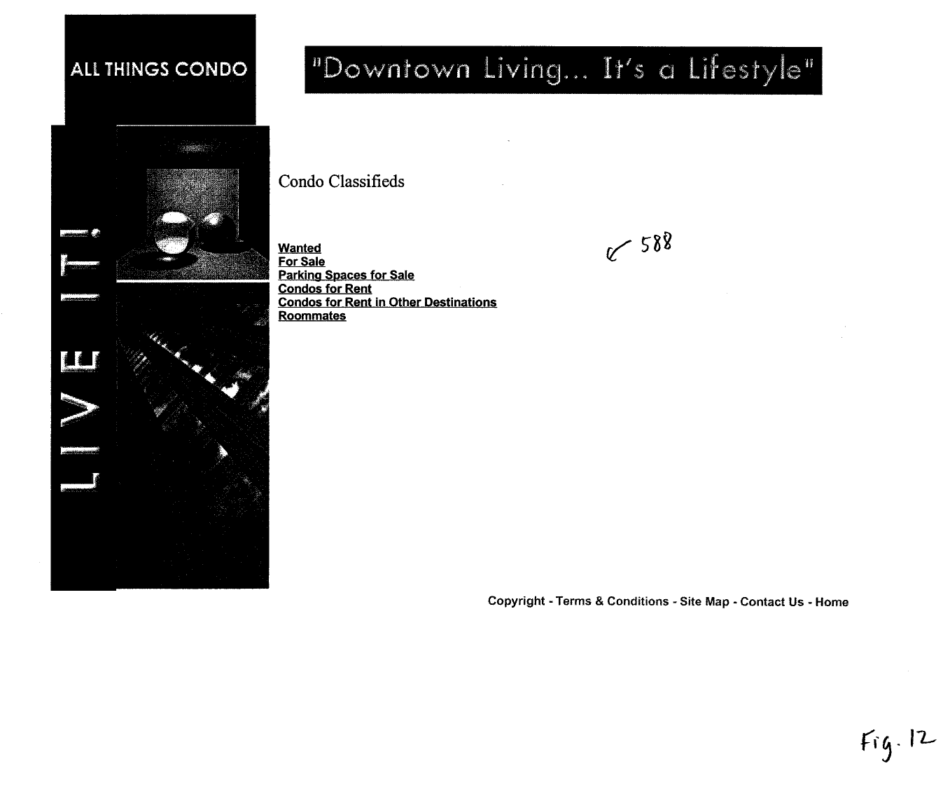

Module 580 also includes a classifieds module 588, shown in FIG. 12, which can assist a user to personally buy or sell a condominium. Module 588 can, for example, provide the user access to “wanted” or “for sale” advertisements for condominiums and parking spaces, information on condominiums for rent, and roommate wanted classifications.

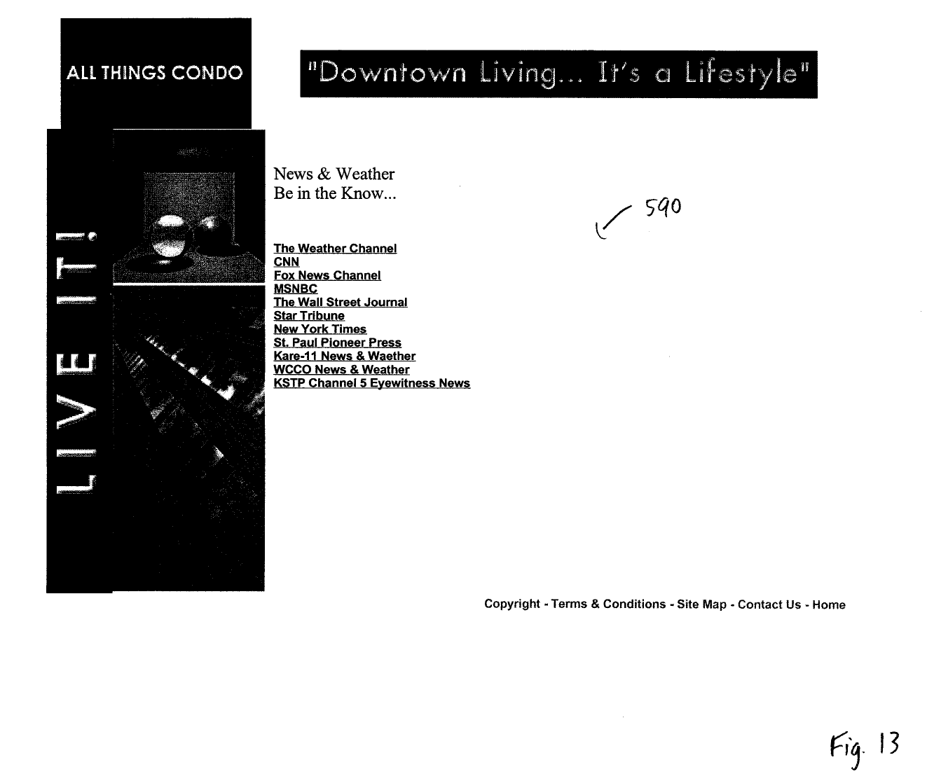

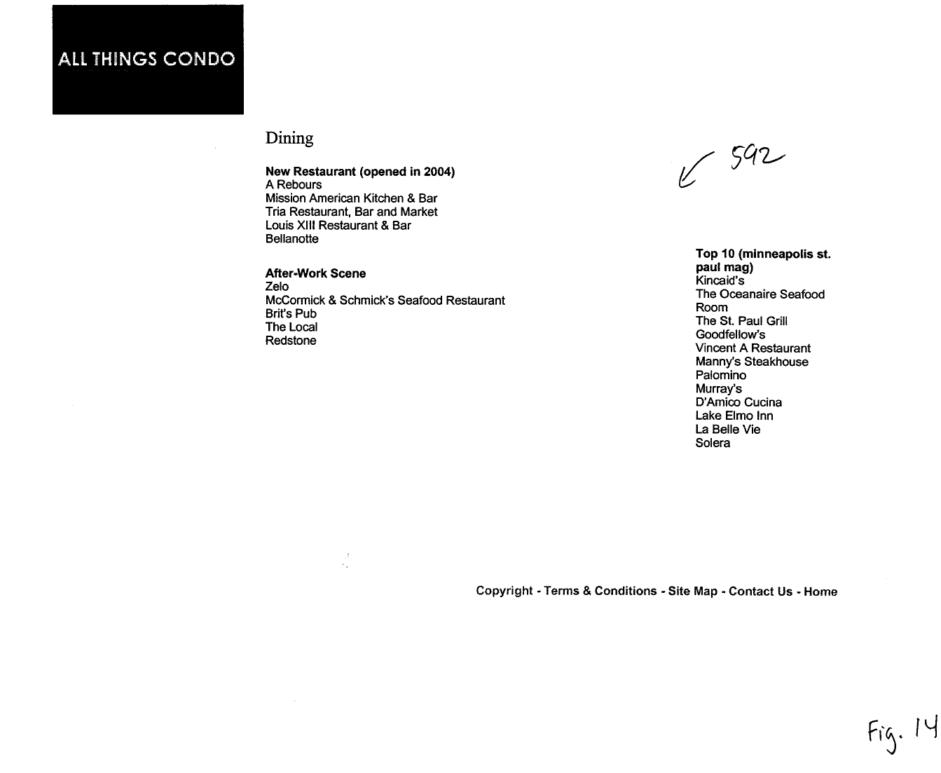

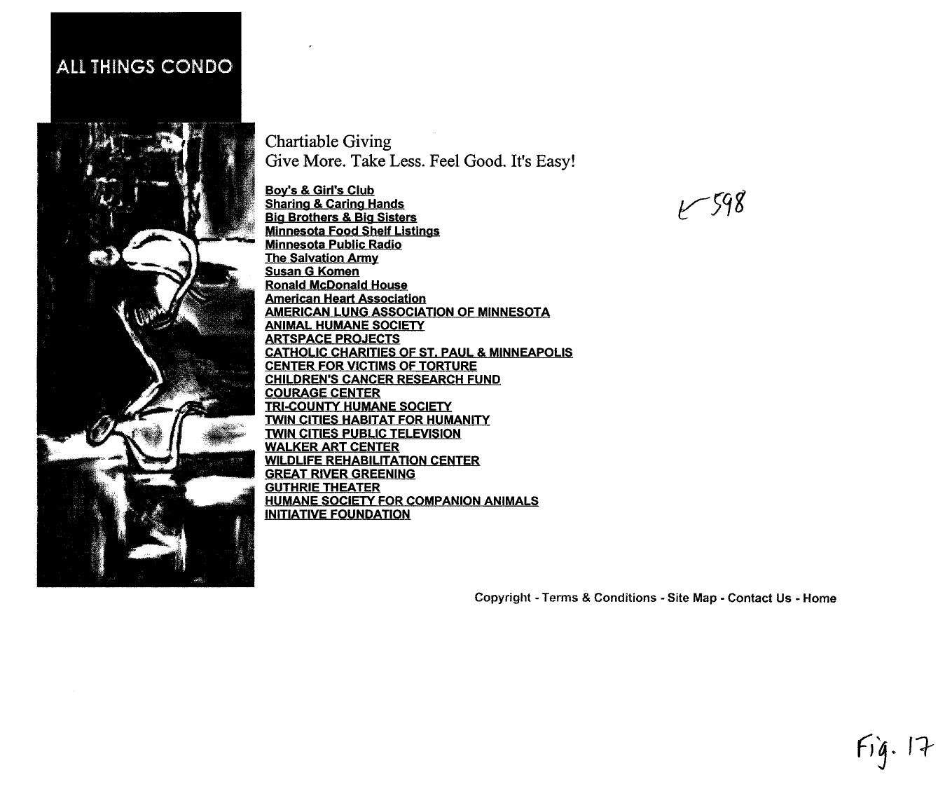

Module 580 also provides access to news module 590, shown in FIG. 13, that provides links for the user to news sources of interest in the particular geographic area. For example, new sources associated with the particular geographic area are listed to allow the user to easily locate news and weather of interest. Module 580 further includes modules 592, 594, and 596, shown in FIGS. 14-16, that respectively provide information related to dining, night life, and arts and theater associated with the particular geographic area. Module 580 can also include non-commercial information of interest to the user, such as charitable module 598, shown in FIG. 17, that provides information related to charities associated with the particular geographic area.

In the illustrated embodiment, information in module 580, such as the information in modules 590, 592, 594, and 596, is developed specifically for system 500. In other embodiments, information can be purchased from an information portal such as, for example, Yahoo! to be used with system 500.

In the example shown, system 500 also includes a link 505 to other systems directed to other geographic areas. In this manner, system 500 can be expanded to cover other geographic areas as described, for example, using method 400 of FIG. 4. A user can locate the system directed to another desired geographic area using link 505.

For example, in some embodiments, system 500 is broken down by geographic area such that, when the user first accesses system 500, the user is presented with a list of geographic areas and selects a particular geographic area in which the user is interested. In one embodiment, system 500 is broken down by zip code.

In other embodiments, a particular geographic area can be further broken down by other factors. For example, in one alternative embodiment, separate content is provided depending on the type of real estate or property being sold. For example, in one embodiment, standard and luxury content is separated for a particular region, so that inexpensive properties can be accessed on one web site, and expensive properties can be accessed on another web site for the particular geographic area.

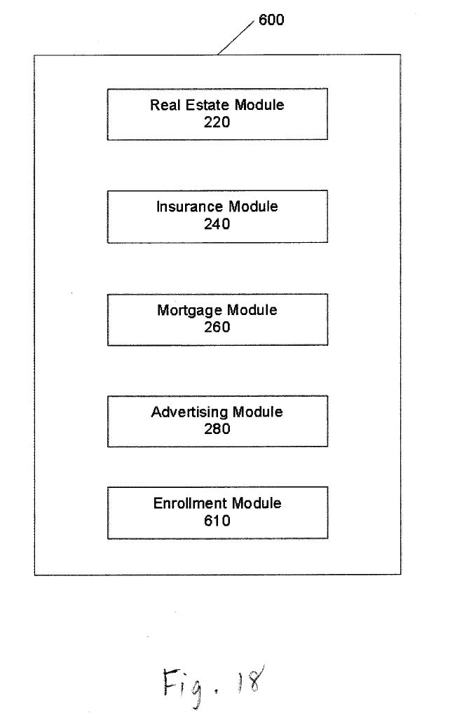

Referring now to FIG. 18, another example system 600 is shown. System 600 is similar to that of system 200, except that system 600 also includes an enrollment module 610. System 600 is configured differently from system 200 in that, instead of selecting providers for each geographic area, the providers are provided with the opportunity to review available geographic areas and to sign up for a desired geographic area.

Enrollment module 610 is accessible by mortgage, real estate, and insurance providers and allows such providers to sign up with system 600 to advertise for a particular geographic area. In example embodiments, enrollment module 610 is automated in that a provider can access the module, provider certain information, and then become the single provider for that geographic area. For example, a mortgage provider can access enrollment module 610, select a particular geographic area, provider content related to the provider and that geographic area, and then become the single provider for that geographic area, as described further below.

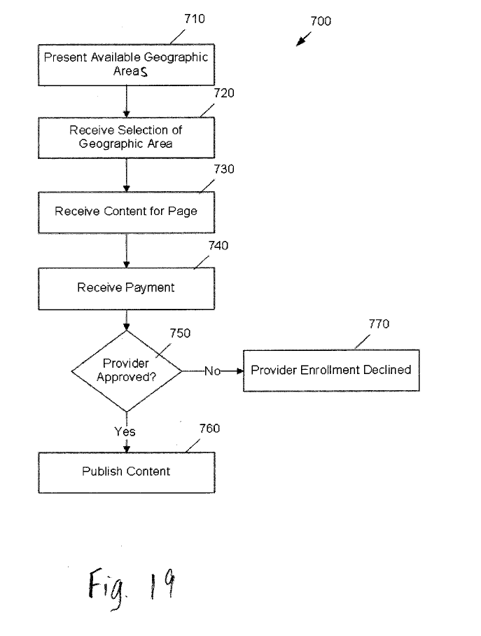

Referring now to FIG. 19, an example method 700 for enrolling a provider is shown. At operation 710, the provider (e.g., mortgage, real estate, or insurance) accesses the system and is presented with a list of available geographic areas that do not yet have a provider. In example embodiments, the geographic areas can be broken down in various ways, such as by zip code, city, county, or state.

In one embodiment, the geographic areas are broken down by zip code. This can be advantageous because dividing the geographic areas by zip code allows for each site to include content at the local level specific to the geographic area.

Next, at operation 720, the selection of one or more geographic areas is received from the provider.

Next, at operation 730, content for the site related to the geographic area is received from the provider. For example, in some embodiments, the provider must provide web links and/or contact information for particular goods and services located in the geographic area. In example embodiments, the provider is required to provide links for specific categories such as, for example, restaurants, health clubs, dry cleaners, etc. This information is used to generate content-specific information for the site related to the geographic area.

In some embodiments, the provider also provides content associated with the provider, such as bibliographic information. For example, if the provider is a mortgage provider, the provider can provide information related to the provider's professional services, past experience, references, photographs, available lending programs, etc.

Next, at operation 740, the provider pays a fee for becoming the single provider for the selected geographic areas. In example embodiments, the fee is a flat fee, although over payment configurations (e.g., a commission-based system) are possible. The fee for a particular geographic area (e.g., zip code) is calculated based on the demographics for the region. For example, a geographic area located in a large metropolitan area has a larger fee associated with it as compared to one in a rural area. In some embodiments, less lucrative geographic areas can be bundled with more lucrative areas so that when a provider signs up for a particular geographic area, the provider receives adjacent less lucrative area as part of a bundle.

Next, at operation 750, the system undergoes an approval process. In example embodiments, the approval process involves review of the content provided by the provider, as well as confirmation of payment. The approval process can be completely automated, semi-automated, or manual. For example, in the completely automated process, the content is automatically checked to make sure that the content refers to live web sites, and the payment is verified electronically. In the semi-automated system, the payment verification is automated, but the content verification is manually performed by a human.

If the provider is approved, control is passed to operation 760 and the content is published for the geographic area. In example embodiments, the provider is the single or sole provider for the particular geographic area for a specified period of time, such as 1 month, 6 months, 1 year, 2 years, or 5 years. At the end of the period, the provider can enroll again.

If the provider is not approved at operation 750, control is passed to operation 770, and enrollment of the provider is declined. For example, if the payment is rejected or the content is not sufficient, the enrollment of the provider can be declined.

In example embodiments, method 710 is performed in an automated fashion by enrollment module 610.

In example embodiments, a single mortgage, real estate, and insurance provider can enroll for a given geographic area. A provider can receive incentives for referring other providers who enroll with the system. For example, if the provider refers another provider that enrolls for a geographic area, the referring provider can receive a cash bonus or other reward.

In example embodiments, once a provider is enrolled on the system, a profile for the provider is created. The profile can be used to help track the provider's interactions with the system and track preferences of the provider. For example, the profile can be used to show the content that has been uploaded to the system by the provider. Examples of such profiles are described in U.S. patent application Ser. No. 60/743,507 filed on Mar. 16, 2006, the entirety of which is hereby incorporated by reference.

In other embodiments, enrollment module 610 can also be configured to allow other sources of contents, such as advertisers, to enroll with system 600. In one embodiment, advertisers can use enrollment module 610 to select a geographic area or areas, upload content and payment, and become advertisers on the sites associated with the geographic areas. In addition, advertisers can selection which sites for the particular geographic area the advertisements will be shown. In one embodiment, the fees for the advertisers can be reduced or tiered based upon the amount of content provided by the advertiser. For example, if the advertiser provides additional content, the fee for enrolling can be reduced.

There advantages associated with the sale of condominiums using the systems and methods described herein. These advantages can include, but are not limited to, convenience, ease of transaction, and location specific real estate, finance, insurance, and service providers. The systems and method can also direct a user to preferred service providers that may help them increase their enjoyment of the purchased condominium (e.g., make a dentist appt, a tee time, dinner reservations, etc.). In addition, once a user purchases a condominium in one geographic area, the user may be more likely to be interested in purchases another condiominium in another geographic area. The user can utilize links on the system to locate the system directed to another desired geographic area to make such a purchase in the other geographic area.

In the example system 500, the information and tools in modules 520, 540, 560, and 580 allow a user to obtain services to hell the user purchase, finance, and insure a condominium using a single resource. In addition, various tools and services (e.g., financial calculator 567) are provided in modules 520, 540, 560, and 580 to further enhance the value to the user. As the value to the user is increased, additional users (new and repeat users) will begin to use system 500. As the user base increases, the value paid by the providers to be listed on system 500 also increases. For example, as the user base increases, advertisers will be willing to pay increased fees to be listed on listed on module 580. This, in turn, will increase the revenue generated system 500.

In addition, by dividing the geographic areas at the local level (e.g., by zip code), local content can be delivered to the user. Further, by requesting content from the providers for each geographic area, the content is further localized.

Although the examples described herein have been described with respect to the sale, insurance, and finance of real estate such as condominiums, the systems and methods described herein can be used with other forms of property as well. For example, the systems and methods can be used in conjunction with the rental/sale of any property for which insurance is desirable. Examples of such property include real estate, motor homes, automobiles, boats, etc. For example, alternative embodiments can include systems and methods directed to provide a single source for the rental/purchase, insurance, and finance of an automobile.

Further, in addition to the services associated with the sale, insurance, and finance of property, other services can also be provided using the systems and methods described herein. For example, investment in property such as condominiums can also be driven using the systems and methods described herein. For example, the systems described herein can also include links to investment providers that assist the user generally in the management of the user's finances, including investments. In this manner, the systems and methods described herein can not only provide a single source of information for the user to purchase, insure, and finance property, but can also assist the user in the overall management of the user's finances.

Although system 500 is described as a web-based system accessible over the Internet, the systems and methods described herein can be applied in other formats as well. For example, system 500 can be presented to users in a print media. In one embodiment, the printed media can be a periodical that includes a printed form of modules 520, 540, 560, and 580.

The above specification, examples and data provide a complete description of the manufacture and use of the composition of the invention. Since many embodiments of the invention can be made without departing from the spirit and scope of the invention, the invention is not limited to the embodiments disclosed herein.

What is claimed is:

1. A system for providing a single source for identifying providers for purchasing, financing, and insuring a piece of property in a geographic area, the system comprising:
a property module programmed to provide information associated with the purchase of the property, including information associated with one or more real estate providers for the geographic area;
a finance module programmed to provide information associated with the financing of the property, including information associated with one or more lending providers for the geographic area; and
an insurance module programmed to provide information associated with the insuring of the property, including information associated with one or more insurance providers for the geographic area.

2. The system of claim 1, wherein the property module is programmed to list a single real estate provider, a single lending provider, and a single insurance provider for the geographic area.

3. The system of claim 2, wherein the system includes a plurality of geographic areas, and wherein only a single real estate provider, lending provider, and insurance provider is listed for each geographic area.

4. The system of claim 1, further comprising an enrollment module programmed to allow a provider to enroll with the system to become a provider for the geographic area.

5. The system of claim 4, wherein the enrollment module is programmed to automatically enroll the provider in the system.

6. The system of claim 1, further comprising an advertising module programmed to provide advertising content specific to the geographic area.

7. A method for providing a single source for identifying providers for purchasing, financing, and insuring a piece of property in a geographic area, the method comprising:
identifying a geographic area;
selecting a real estate provider for the geographic area;
selecting an insurance provider for the geographic area;
selecting a mortgage provider for the geographic area;
allowing access to information about the real estate provider, the insurance provider, and the mortgage provider for the geographic area at a single source.

8. The method of claim 7, further comprising listing only a single real estate provider, lending provider, and insurance provider for the geographic area.

9. The method of claim 8, further comprising establishing a relationship with each of the single real estate provider, lending provider, and insurance provider for the geographic area.

10. The method of claim 7, further comprising listing information for a plurality of geographic areas, wherein only a single real estate provider, lending provider, and insurance provider is listed for each geographic area.

11. The method of claim 7, further comprising:
selecting another geographic area; and
selecting another real estate provider, another insurance provider, and another mortgage provider for the other geographic area.

12. The method of claim 7, further comprising enrolling a provider for the geographic area.

13. The method of claim 7, further comprising generating advertising content specific to the geographic area.

14. A method for automatically enrolling a provider in a system including a source for purchasing, financing, and insuring a piece of property, the method comprising:
listing a plurality of geographic areas that are available for the provider;
receiving a selection of a geographic area from the provider;
receiving content for a site associated with the geographic area from the provider;
receiving payment from the provider;
determining if the provider qualifies for enrollment for the geographic area; and
enrolling the provider if the provider qualifies.

15. The method of claim 14, wherein the provider is a mortgage, real estate, or insurance provider.

16. The method of claim 14, wherein the step of receiving content further comprises receiving content associated with the geographic area.

17. The method of claim 14, wherein the step of determining if the provider qualifies further comprises checking the content and the payment provided by the provider.

18. The method of claim 14, further comprising publishing the content from the provider on the site associated with the geographic area.

19. The method of claim 14, wherein the step of enrolling the provider further comprises enrolling the provider for a specified period of time.

20. The method of claim 19, further comprising:
removing the provider after the specified period of time; and
listing the geographic area as being available for another provider.
